(19) United States
(12) Patent Application Publication
(10) Pub. No.: US 2017/0289306 A1
(43) Pub. Date: Oct. 5, 2017

(54) METHOD, DEVICE AND STORAGE MEDIUM FOR SYNCHRONIZING STATES

(71) Applicant: Beijing Xiaomi Mobile Software Co., Ltd., Beijing (CN)

(72) Inventors: Kangxi Tan, Beijing (CN); Xin Liang, Beijing (CN); Chao Xu, Beijing (CN)

(73) Assignee: Beijing Xiaomi Mobile Software Co., Ltd., Beijing (CN)

(21) Appl. No.: 15/450,513

(22) Filed: Mar. 6, 2017

(30) Foreign Application Priority Data
Mar. 29, 2016 (CN) 201610189245.2

(51) Int. Cl. H04L 29/08

(52) U.S. Cl. CPC H04L 67/32; H04L 67/14; H04L 67/306

(57) ABSTRACT

Provided are a method, a device and storage medium for synchronizing states, which belongs to the field of communication technology. Synchronizing states includes acquiring a usage state of target contact information of a target user, detecting whether the usage state of the target contact information has changed based on previously-stored usage states of respective contact information, if the usage state of the target contact information has changed, acquiring a target contact list for the target user, and synchronizing the usage state of the target contact information to contacts in the target contact list.

### CROSS-REFERENCE TO RELATED APPLICATIONS

The present application claims priority to Chinese Patent Application 201610189245.2, filed Mar. 29, 2016, the entirety of which is incorporated by reference herein.

### TECHNICAL FIELD

The present disclosure relates to the field of communication technology, and more particularly, to a method, a device and storage medium for synchronizing contact information states to provide notice to related contacts when a user's contact information changes.

### BACKGROUND

In daily life, a user may change their contact information, such as: a cell phone number of the user, an e-mail address of the user.

In the related art, the user would need to send their new changed contact information to each contact in the user's contact list after the user changes their contact information. For example, user A would have needed to manually send the user's new cell phone number to every friend in the user's contact list after the user changes their cell phone number.

### SUMMARY

The present disclosure provides a method, a device, and storage medium storing instructions for synchronizing states of a user's contact list when the user's contact information is changed. The technical solution is as follows.

According to a first embodiment of the present disclosure, there is provided a method for synchronizing states, including: acquiring a usage state of target contact information of a target user; detecting whether the usage state of the target contact information has changed based on previously-stored usage states of respective contact information; if the usage state of the target contact information has changed, acquiring a target contact list of the target user; and synchronizing the usage state of the target contact information to contacts in the target contact list.

According to a second embodiment of the present disclosure, there is provided a method for synchronizing states, including: receiving a setting signal; setting a usage state of target contact information based on the setting signal; and sending the set usage state of the target contact information to a server, such that the server synchronizes the usage state of the target contact information to contacts in a contact list of a terminal when detecting that the usage stage of the target contact information has changed.

According to a third embodiment of the present disclosure, there is provided a device for synchronizing states, including: a processor; and a memory for storing instructions executable by the processor, wherein the processor is configured to perform: acquiring a usage state of target contact information of a target user; detecting whether the usage state of the target contact information has changed based on previously-stored usage states of respective contact information; if the usage state of the target contact information has changed, acquiring a target contact list of the target user; and synchronizing the usage state of the target contact information to contacts in the target contact list.

According to a fourth embodiment of the present disclosure, there is provided a device for synchronizing states, including: a processor; and a memory for storing instructions executable by the processor, wherein the processor is configured to perform: receiving a setting signal; setting a usage state of target contact information based on the setting signal; and sending the set usage state of the target contact information to a server, such that the server synchronizes the usage state of the target contact information to contacts in a contact list of a terminal when detecting that the usage stage of the target contact information has changed.

According to a fifth embodiment, a non-transitory computer-readable storage medium is provided. The non-transitory computer-readable storage medium have stored therein instructions that, when executed by one or more processors of an apparatus, cause the apparatus to perform acts including: acquiring a usage state of target contact information of a target user; detecting whether the usage state of the target contact information has changed based on previously-stored usage states of respective contact information; if the usage state of the target contact information has changed, acquiring a target contact list of the target user; and synchronizing the usage state of the target contact information to contacts in the target contact list.

According to a sixth embodiment of the present disclosure, a non-transitory computer-readable storage medium is provided. The non-transitory computer-readable storage medium have stored therein instructions that, when executed by one or more processors of an apparatus, cause the apparatus to perform acts including: receiving a setting signal; setting a usage state of target contact information based on the setting signal; and sending the set usage state of the target contact information to a server, such that the server synchronizes the usage state of the target contact information to contacts in a contact list of a terminal when detecting that the usage stage of the target contact information has changed.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for synchronizing states according to an exemplary embodiment;

FIG. 2 is a flow chart showing a method for synchronizing states according to an exemplary embodiment;

FIG. 3A is a flow chart showing a method for synchronizing states according to another exemplary embodiment;

FIG. 3B is a schematic diagram showing a method for setting a usage state according to an exemplary embodiment;

FIG. 3C is a schematic diagram showing a method for setting a usage state according to another exemplary embodiment;

FIG. 4A is a flow chart showing a method for synchronizing states according to a further exemplary embodiment;

FIG. 4B is a display schematic diagram showing usage states in a contact list according to an exemplary embodiment;

FIG. 5A is a flow chart showing a method for synchronizing states according to a still further exemplary embodiment;

FIG. 5B is a schematic diagram showing a method for setting usage states of contacts according to an exemplary embodiment;

FIG. 6 is a block diagram showing a device for synchronizing states according to an exemplary embodiment;

FIG. 7 is a block diagram showing a device for synchronizing states according to another exemplary embodiment;

FIG. 8 is a block diagram showing a device for synchronizing states according to an exemplary embodiment; and

FIG. 9 is a block diagram showing a device for synchronizing states according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are examples of devices and methods consistent with aspects related to the present disclosure as recited in the appended claims.

The method for synchronizing states according to embodiments of the present disclosure is applicable to a situation when target contact information of a target user has changed. In such a situation, a server may synchronize a usage state of the target contact information associated with the target user with contacts in a target contact list of the target user. Synchronizing the usage state of the target contact information with the contacts in the target contact list may result in the contacts in the target contact list to learn about the change in the target user's contact information. An “in-use” usage state may be assigned to contact information for a user (e.g., a user's contact information such as cell phone number or e-mail address), where the “in-use” usage state indicates the contact information is valid and/or current. A “non-use” usage state may be assigned to contact information for a user, where the “non-use” usage state indicates the contact information is no longer valid and/or is not current (e.g., the contact information has been updated more recently).

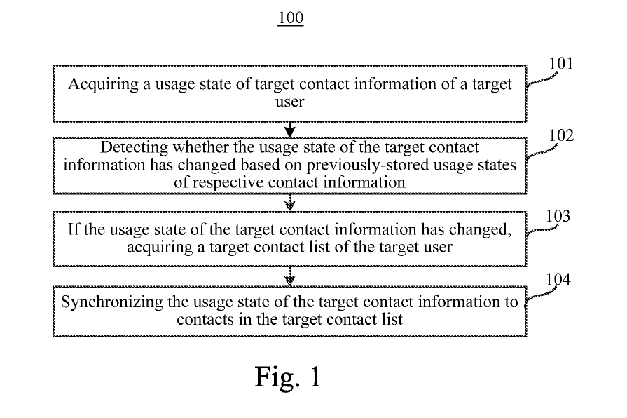

FIG. 1 shows a flow chart 100 describing a method for synchronizing states according to an exemplary embodiment. As shown in FIG. 1, the method for synchronizing states may be implemented, at least in part, by a server. The method for synchronizing states may include the following steps.

In step 101, a usage state for a target contact information associated with a target user may be acquired by the server. The target contact information may include one or more of the following contact information types: the target user's phone number (e.g., home phone number, office phone number, fax phone number, cell phone number), address information (work address, home address), email address, electronic message user name, or other contact information associated with the target user.

In step 102, the server detects whether the usage state of the target contact information has changed compared to previously stored (i.e., previously-stored) usage states of respective contact information. A usage state may identify whether contact information associated with the target user is currently in use or is not currently in use. For example, the detection at step 102 may compare a current usage state assigned to a contact information (e.g., phone number) against a previously stored usage state for the same contact information to determine whether a change has been made. Each type of contact information (e.g., mobile phone number, home phone number, business phone number, email address, mailing address), may have its own usage state (both current usage state and/or previously stored usage state).

In step 103, if the usage state of the target contact information has changed, a target contact list of the target user is acquired by the server. The target contact list may include one or more contacts (e.g., contact information for people or entities) related to the target user, and the target contact list may be stored locally on the target user's computing device or stored on the server. For each contact in the target contact list, one or more types of contact information may be saved for the respective contact.

In step 104, the usage state of the target contact information may be synchronized to contacts in the target contact list. Synchronizing the usage state of the target contact information may include sending a notification identifying the changed usage state, and/or identifying the new target contact information, to the contacts in the target contact list. In addition or alternatively, synchronizing the usage state of the target contact information may include accessing contact lists for contacts included in the target contact list, and updating the target user's new usage state and/or new target contact information in the accessed contact lists. The contact lists for the contacts included in the target contact list may be stored on the server.

Accordingly, in the method for synchronizing states provided by the flow chart 100, a usage state of target contact information of a target user may be acquired. It is detected whether the usage state of the target contact information has changed based on previously-stored usage states of respective contact information. When the usage state of the target contact information has changed, a target contact list of the target user is acquired, and the usage state of the target contact information is synchronized to contacts in the target contact list. The server may detect whether the usage state of the target contact information has changed, and automatically synchronize the usage state of the target contact information to the contacts in the target contact list when it is detected that the usage state of the target contact information has changed. This provides a technical solution to the technical problem where a user needs to manually send changed contact information to each contact in a contact list after the user changes their contact information. The technical solution achieves an effect that the usage state of the target contact information is automatically synchronized to the contacts in the target contact list when the usage state of the target contact information has changed, i.e. automatically synchronizing the usage state of the target contact information.

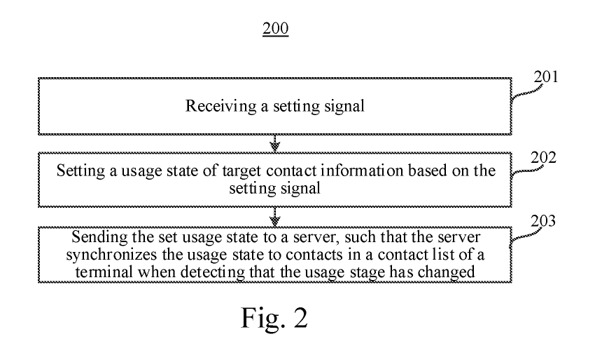

FIG. 2 shows a flow chart 200 describing a method for synchronizing states according to an exemplary embodiment. As shown in FIG. 2, the method for synchronizing states may be implemented in a terminal, where the terminal is a computing device in communication with a server (e.g., server described with reference to flow chart 100 in FIG. 1). It should be noted that, the terminal in embodiments of the present disclosure may be a smart phone, a tablet PC, a smart television, an e-book reader, a multimedia player or other computing device. The method for synchronizing states may include the following steps.

In step 201, a setting signal is received by the terminal. The setting signal may originate and be generated from an application running on the terminal for monitoring a state of the target user's contact information. In addition or alternatively, the setting signal may be a command input that is input by the target user into the terminal. For example, the target user may be interacting with a graphical user interface presented on the terminal to input the setting signal. The received setting signal may cause the terminal to change a usage state from “non-use” to “in-use,” or vice-versa, based on the instructions included in the setting signal.

In step 202, a usage state of target contact information associated with the target user is set based on the setting signal, and following any changes to the usage state initiated by the setting signal. For example, the terminal may determine the usage state for one or more different types of target contact information associated with the target user (e.g., target user's cell phone number, e-mail address, mailing address, or other types of contact information). The usage state may indicate whether the particular terminal contact information is in an “in-use” state or a “non-use” state.

In step 203, the set usage state of the target contact information is sent to a server, such that the server may synchronize the usage state of the target contact information to contacts in the target user's contact list stored on the terminal when detecting that the usage stage of the target contact information has changed. Alternatively, when the user's contact list is stored on the server, the server may synchronize the usage state of the target contact information to contacts in the target user's contact list directly.

Accordingly, in the method for synchronizing states provided by the flow chart 200, a setting signal is received by the terminal and a usage state of target contact information is set based on the received setting signal. The set usage state of the target contact information is sent to a server, such that the server synchronizes the usage state of the target contact information to contacts in a contact list stored on the terminal when detecting the usage stage of the target contact information has changed. The terminal sets a usage state of target contact information based on the setting signal and sends the set usage state to a server. This solves a technical problem where a user needs to manually send changed contact information to each contact in a contact list after he/she changes his/her contact information, and achieves an effect that the usage state of the target contact information is automatically synchronized to the contacts in the target contact list when the usage state of the target contact information has changed, i.e. automatically synchronizing the usage state of the target contact information.

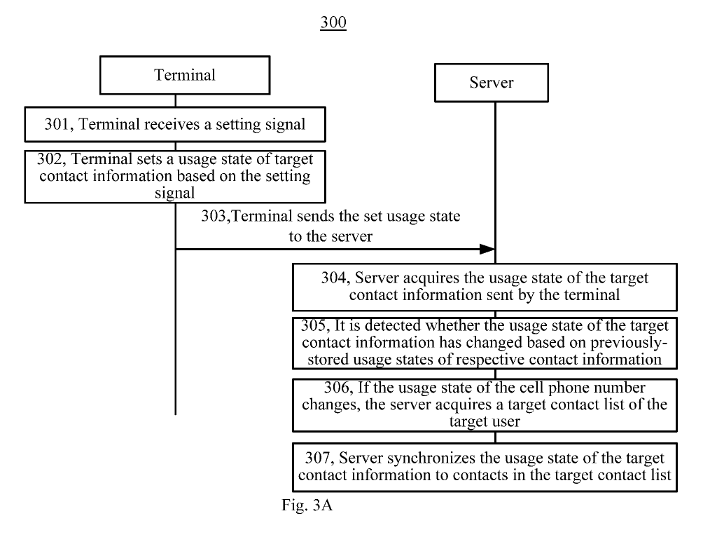

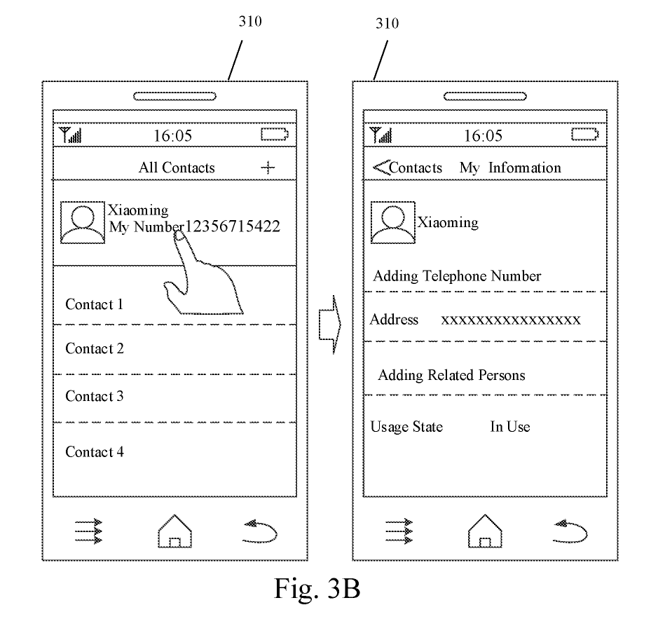

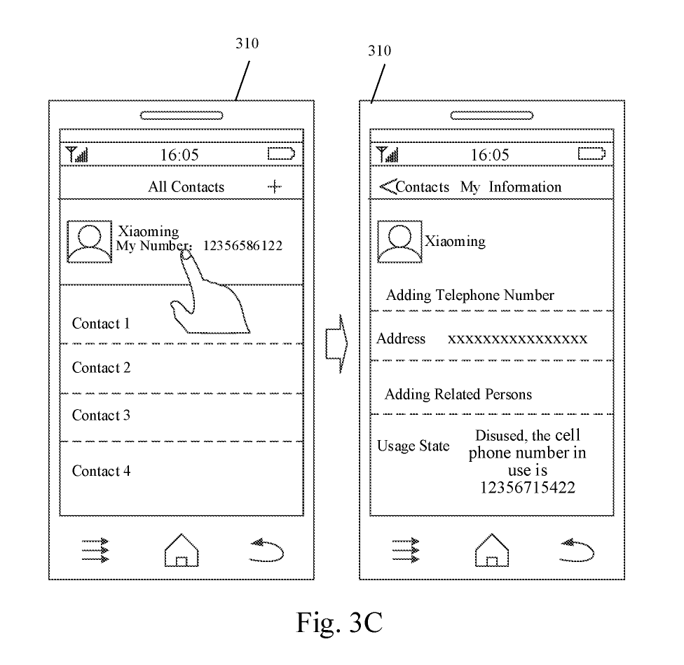

FIG. 3A shows a flow chart 300 describing a method for synchronizing states according to another exemplary embodiment. As shown in FIG. 3A, the method for synchronizing states may include the following steps.

In step 301, the terminal receives a setting signal.

When a target user wishes to set a usage state of his/her own contact information, the target user may input a setting signal for setting the usage state of his/her own contact information in the terminal. It follows that the terminal may receive the setting signal in this way. The target contact information may refer to the target user's own contact information.

The target contact information may include any one or more of a cell phone number, an e-mail address, or a social account. A content of the target contact information is not specifically limited to embodiments of the present disclosure. The setting signal may include a new input signal for adding a usage state for the target contact information, or an updating signal for updating an existing usage state of the target contact information.

Optionally, the target user may set the usage state by setting a state label or a state identification in a graphical user interface (GUI) displayed on a display screen of the terminal. Thus, the terminal may receive a corresponding setting signal.

Referring to FIG. 3B, for example, shows an exemplary GUI displayed on a display screen of exemplary terminal 310. After the target user changes his/her cell phone number, when he/she would like to set the usage state of the cell phone number as an “in-use” state, he/she may click a “My Number” function (e.g., GUI button) to open a “My Information” editing interface, and input a setting signal identifying the usage state of the cell phone number to be in the “in-use” state in the editing interface.

For another example, when the target user ceases to use the cell phone number and wants to update the usage state of the cell phone number from the “in-use” to a “non-use” state, he/she may input an updating signal which updates the usage state of the cell phone number to the “non-use” state in the terminal.

It should be noted that, the terminal in embodiments of the present disclosure may be a smart phone, a tablet PC, a smart television, an e-book reader, a multimedia player or other computing device.

In step 302, the terminal sets a usage state for the target contact information based on the received setting signal.

When the usage state of the target contact information is updated from the “in-use” state to the “non-use” state, the user may further input a setting signal into the GUI displayed on the terminal which sets the updated target contact information. At this time, the terminal may set the updated target contact information correspondingly based on the received setting signal.

The usage state of the updated target contact information and the usage state of previous target contact information may be set simultaneously. For example, when the user needs to change his/her cell phone number and wants to set the usage state of the cell phone number, he/she may click “My Number” to open an editing interface of “My Information” and first edit the usage state of the previous cell phone number in the editing interface to a “non-use” state, and then add information for the usage state including information on the current cell phone number in use. The added information may include, for example, “Non-used, the cell phone number in use is 12356715422”, as shown by the exemplary GUI displayed on the terminal 310 in FIG. 3C.

In step 303, the terminal sends the set usage state of the target contact information to a server.

After setting the usage state of the target contact information based on the received setting signal, the terminal sends the set usage state of the target contact information to the server.

In step 304, the server acquires the usage state of the target contact information by receiving the set usage state sent by the terminal.

In step 305, it is detected whether the usage state of the target contact information has changed based on previously-stored usage states of respective contact information.

After acquiring the usage state of the target contact information sent by the terminal, the server detects whether the acquired usage state of the target contact information has changed compared to previously stored usage states of respective contact information (e.g. has the usage state for the target user's cell phone number changed when comparing a previous usage state versus the current usage state for the same cell phone number).

When the usage state of the target contact information acquired most recently is different from a previously-stored usage state of the same target contact information, the server determines that the usage state of the target contact information has changed. When the usage state of the target contact information acquired most recently is the same as a previously-stored usage state of the same target contact information, it is determined that the usage state of the target contact information has not change.

For example, when the server receives a usage state of the cell phone number 12356715422, indicating a “non-use” state, sent by the terminal, the server detects whether a usage state of this cell phone number is stored in a previously-stored list of usage states of contact information based on the cell phone number. If the server detects that a usage state of this cell phone number is stored in the previously-stored list of usage state of contact information, it acquires the previously-stored usage stage of this cell phone number. Assuming that the previously-stored usage stage is in the “in-use” state, the server compares the “non-use” usage state acquired most recently and the previously-stored “in-use” usage state. Since the usage state acquired most recently is different from the previously-stored usage state, the server determines that the usage state of this cell phone number has changed. If the server detects that no usage state corresponding to this cell phone number is stored in the previously-stored list of usage state of contact information, the server determines that the usage state of the contact information is a newly added usage state. At this time, the server may also determine that the usage state for this cell phone number has changed.

In step 306, if the usage state of the target contact information is determined to have changed, the server acquires a target contact list associated with the target user.

When the server determines that the usage state of the target contact information has changed, the server acquires the target contact list of the target user based on the target contact information.

The target contact list of respective contact information associated with the target user may be previously-stored in a memory of the server, such that acquiring the target contact list comprises accessing the target contact list from the memory. When the server recognizes that the usage state of the target contact information has changed, the server may acquire the target contact list corresponding to the target contact information.

If the usage state of target contact information is determined not to have changed, the server may skip the following step 307.

In step 307, the server synchronizes the usage state of the target contact information to contacts in the target contact list.

After the server acquires the target contact list, the server may read contact information corresponding to respective contacts in the target contact list. The server synchronizes the usage state of the target contact information to respective contacts based on the read contact information.

For example, when the server determines that the usage state of the cell phone number 12356715422 is updated to the “in-use” state, then the server acquires the target contact list corresponding to the target user having the cell phone number 12356715422, and reads contact information in the acquired target contact list. The server then synchronizes “12356715422+in use” to respective contacts in the target contact list based on the read contact information. Synchronizing may include both reading and updating the contact information, as well as presenting the updated contact information to the respective contacts in the target contact list (e.g., text message, email, automated voice message).

Optionally, when the usage state of the target contact information is updated to the “non-use” state, the server may further acquire the updated target contact information, and synchronize the updated target contact information to contacts in the target contact list. Optionally, the server may synchronize the updated target contact information along with the previous target contact information to respective contacts in the target contact list.

For example, when the server recognizes that the usage state of the cell phone number 12356715422 reported by the terminal is changed from the “in-use” state to the “non-use” state, the server may acquire the target contact list corresponding to the target user having the cell phone number 12356715422, and transmits the message, “cell phone number 12356715422+non-use, and the number in use is 12356715432,” to respective contacts in the target contact list.

A synchronization mode where the server synchronizes the usage state of the target contact information may include short messages, e-mails or automatically updating the usage state of the target contact information in preset contact lists of respective contacts in the target contact list. The present embodiment does not specifically limit the mode that the server synchronizes the usage state of the target contact information.

For example, when the usage state of the cell phone number for the target user has changed, the server may edit the usage state of the cell phone number for the target user into a short message and send it to one or more contacts included in the target contact list of the target user. For another example, when the usage state of the e-mail address for the target user has changed, the server may edit the usage state of the e-mail address into an e-mail form indicating the target user's email has changed, and send the e-mail form to one or more contacts included in the target contact list for the target user.

For still another example, when the usage state of the cell phone number for the target user has changed, the server may directly update the usage state for the cell phone number, as well as the target user's cell phone number, in contact lists associated with contacts included in the target user's target contact list. This may be accomplished when the contact lists are commonly stored on the server to give the server access to the different contact lists, and the authority to update the target user's cell phone number on the contact lists of those contacts that are included in the target user's target contact list.

Accordingly, in the method for synchronizing states provided by embodiments of the present disclosure, a usage state for target contact information of a target user is acquired, whether the usage state of the target contact information has changed is detected and determined based on previously-stored usage states of respective contact information, and if the usage state of the target contact information has changed, a target contact list of the target user is acquired. The usage state of the target contact information may then be synchronized to contacts in the target contact list. A server detects whether the usage state of the target contact information has changed, and automatically synchronizes the usage state of the target contact information to the contacts in the target contact list when it is detected that the usage state of the target contact information has changed. This solves a problem that a user needs to manually send changed contact information to each contact in the user's contact list after he/she changes his/her contact information. This also achieves an effect that the usage state of the target contact information is automatically synchronized to the contacts in the target contact list when the usage state of the target contact information has changed, i.e. automatically synchronizing the usage state of the target contact information.

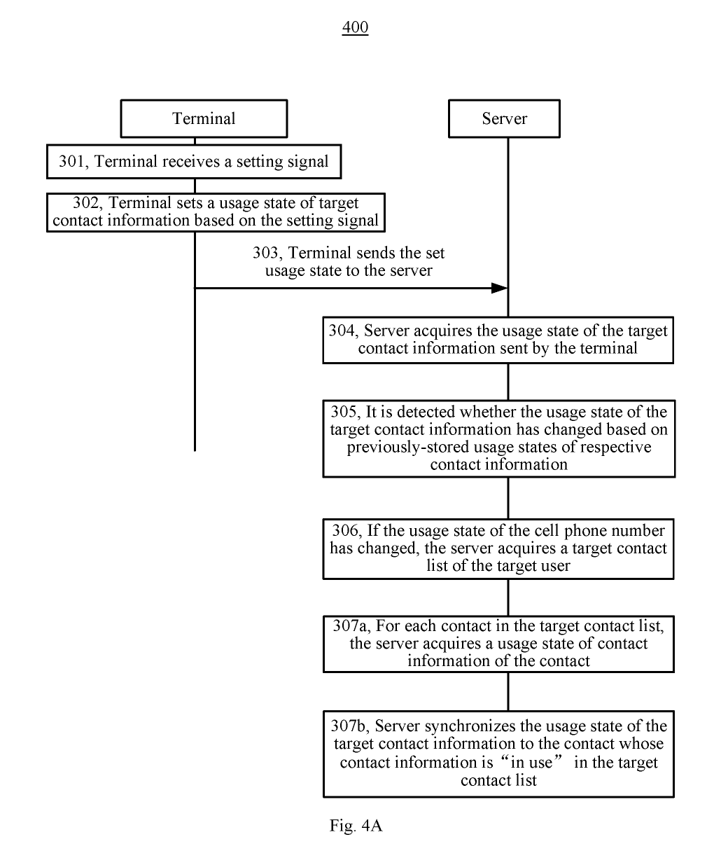

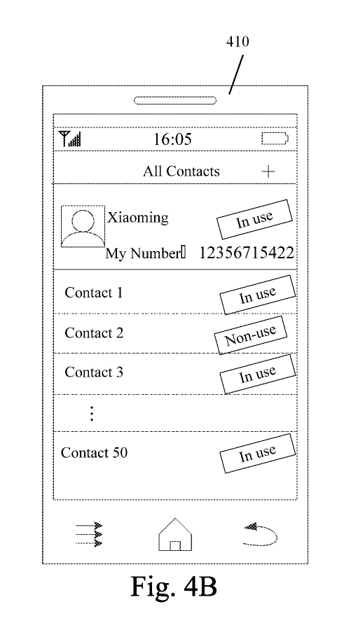

Based on the embodiment as shown in FIG. 3A, the server synchronizes the usage state of the target contact information to respective contacts in the target contact list. As a possible implementation, the server may be configured to synchronize the changed usage states of target contact information for only those contacts whose contact information is identified as being in the “in-use” state in the target contact list. Therefore, referring to FIG. 4A, the step 307 in flow chart 300 may be replaced by the following steps 307a and 307b in flow chart 400.

In step 307a, for each contact in the target contact list, the server acquires the usage states for their contact information.

After the server acquires the target contact list of the target user, it reads contact information corresponding to each contact in the target contact list, and acquires the usage state of each contact information. For example, for contact A, the usage state of a cell phone number contact information and an e-mail address contact information may be acquired.

Optionally, the usage state of each contact information is previously stored in the server. After the server reads contact information of each contact in the target contact list, the server acquires the usage state corresponding to contact information of each contact in the target contact list.

For example, when the cell phone number of a user A is 12356715422, and the usage state of the cell phone number is “in-use”. The contact list of the user A includes: a contact 1, a contact 2, a contact 3, . . . , up to a contact 50. The usage state of the contact 1 is “in-use”, the usage state of the contact 2 is “non-use”, the usage state of the contact 3 is “in-use”, . . . , and the usage state of the contact 50 is “in-use”, as shown in the cell phone 410 of user A shown in FIG. 4B.

For each contact in the target contact list, the usage state of each contact information may be stored in the target contact list, so that the target contact may learn the contact information being used by each contact based on the usage state of each contact information in the target contact list.

In step 307b, the server may synchronize the usage state of the target contact information to only those contacts whose contact information is determined to be in the “in-use” state in the target contact list. After acquiring the usage state of contact information of each contact in the target contact list, the server reads respective contact information is “in-use” (i.e. the usage state of contact information is “in-use”) in the target contact list, and synchronizes the usage state of the target contact information to contacts corresponding to the read respective contact information is “in-use”.

Accordingly, in the method for synchronizing states provided by embodiments of the present disclosure, a usage state of target contact information of a target user is acquired, whether the usage state of the target contact information has changed is detected and determined based on previously-stored usage states of respective contact information, and if the usage state of the target contact information has changed, a target contact list of the target user is acquired. The usage state for the target contact information may be synchronized to contacts in the target contact list. A server detects whether the usage state of the target contact information has changed, and automatically synchronizes the usage state of the target contact information to the contacts in the target contact list when it is detected that the usage state of the target contact information has changed. This solves a problem that a user needs to manually send changed contact information to each contact in a contact list after he/she changes his/her contact information; and achieves an effect that the usage state of the target contact information is automatically synchronized to the contacts in the target contact list when the usage state of the target contact information has changed, i.e. automatically synchronizing the usage state of the target contact information.

Further, the server may only synchronize the usage state of the target contact information to contacts whose contact information is determined to be in the “in-use” state in the target contact list. This way, contacts whose contact information is determined to be in the “non-used” state in the target contact list will not receive the usage state of the target contact information synchronized by the server. Thus, the server does not need to synchronize the usage state of the target contact information to contacts whose contact information is “non-used”, which reduces possibility of wasting server source, and also guarantees safety of the target contact information at the same time.

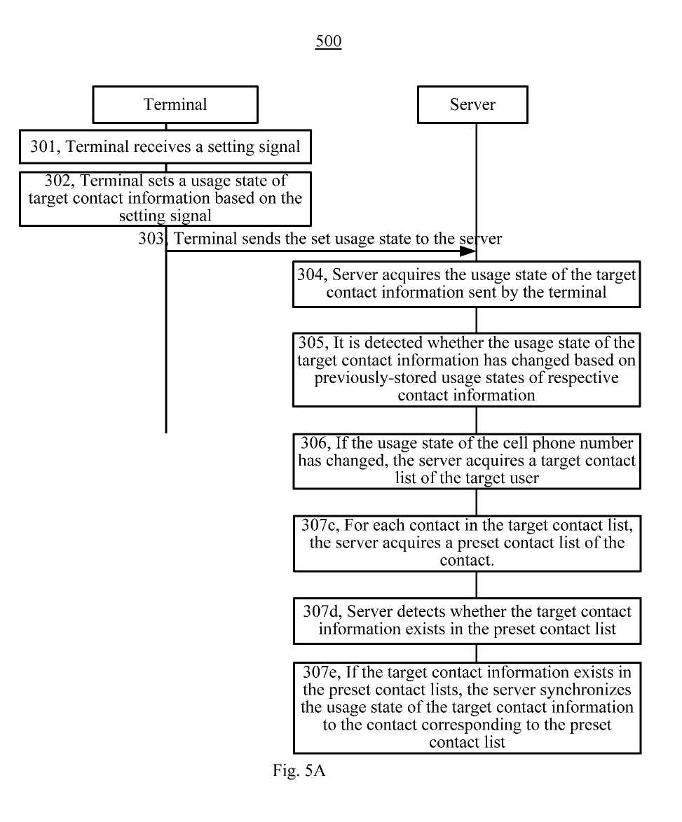

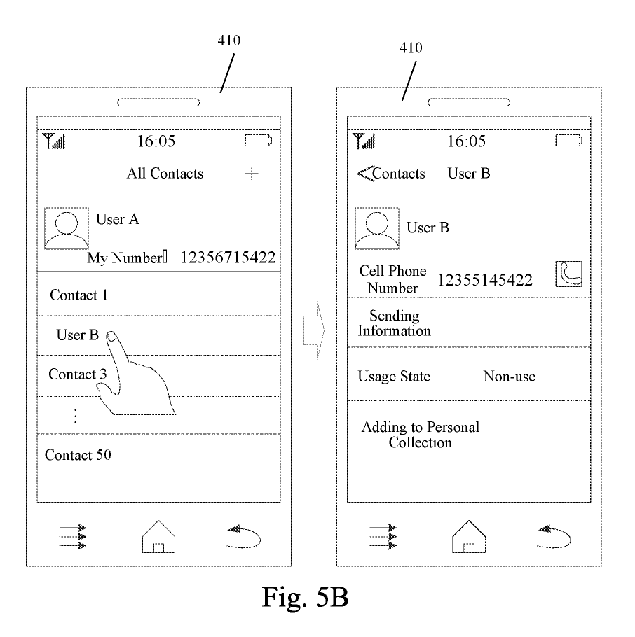

Based on the embodiment as shown in FIG. 3A, the server synchronizes the usage state of the target contact information to respective contacts in the target contact list. As another possible implementation, the server may only synchronize the usage state of the target contact information to contacts whose preset contact lists have the target contact information among contacts in the target contact list. Therefore, referring to FIG. 5A, the step 307 in flow chart 300 may be replaced by the following steps 307c, 307d, and 307e in flow chart 500.

In step 307c, for each contact in the target contact list, the server acquires a preset contact list associated with the contact.

After acquiring the target contact list of the target user, the server reads contact information of each contact in the target contact list. The server may then acquire the preset contact list associated with each contact, where the preset contact list may refer to contact lists associated with the contact. The preset contact list may be stored on a memory of the server, and therefore may be accessible by the server. The preset contact list may be acquired based on each of the read contact information and previously-stored contact lists corresponding to respective contacts.

In step 307d, the server detects whether the target contact information for the target user reciprocally exists in the preset contact lists.

After acquiring the preset contact list of each contact, the server detects whether the target contact information reciprocally exists in the acquired preset contact lists of the contacts in the target user's target contact list.

For example, when the target user is a user A, the target contact list for user A may include 100 contacts, from contact 1 to contact 100, respectively. In this case, the server may detect whether the target contact information of the user A exists in the preset contact lists corresponding to the contact 1, the contact 2, . . . , and up through the contact 100, respectively.

In step 307e, if the target contact information exists in the preset contact lists, the server synchronizes the usage state of the target contact information to the contacts determined to include the target contact information in their respective preset contact lists.

When the target contact information exists in the preset contact lists, since the contacts corresponding to the preset contact lists also have the target contact information, this may be referenced by the server to indicate that there is a friend relationship between the target user and the contacts determined to include the target contact information in their respective preset contact lists. Thus, the server synchronizes the usage state of the target contact information (of the target user) to contacts determined to include the target contact information in their respective preset contact lists.

Optionally, if the target contact information does not exist in the preset contact lists, the server does not synchronize the usage state of the target contact information to contacts corresponding to the preset contact lists.

When the target contact information does not exist in the preset contact lists, since contacts corresponding to the preset contact lists do not have the target contact information, the server may interpret this relationship as indicating that there may be no friendly relationship between the target user and the contacts corresponding to the preset contact lists. Thus, the server may not synchronize the usage state of the target contact information to contacts corresponding to the preset contact lists that do not include the target user's contact information.

For example, the target contact list of the user A includes 100 contacts, from contact 1 to contact 100, respectively. Preset contact lists corresponding to the contacts 1 to 10 may be determined not to include the contact information of the user A, and preset contact lists corresponding to the contacts 11 to 100 may be determined to include the contact information of the user A. In this scenario, the server synchronizes the usage state of the contact information of the user A to contacts 11 to 100 determined to include the contact information of the user A. Further, the server may not synchronize the usage state of the contact information of the user A to contacts 1 to 10 determined not to include the contact information of the user A.

Accordingly, in the method for synchronizing states provided by embodiments of the present disclosure, a usage state of target contact information of a target user is acquired, it is detected whether the usage state of the target contact information has changed based on previously-stored usage states of respective contact information, and if the usage state of the target contact information has changed, a target contact list of the target user is acquired and the usage state of the target contact information is synchronized to contacts in the target contact list. A server detects whether the usage state of the target contact information has changed, and automatically synchronizes the usage state of the target contact information to the contacts in the target contact list when it is detected that the usage state of the target contact information has changed. It solves a problem that a user needs to manually send changed contact information to each contact in a contact list after he/she changes his/her contact information, and achieves an effect that the usage state of the target contact information is automatically synchronized to the contacts in the target contact list when the usage state of the target contact information has changed, i.e. automatically synchronizing the usage state of the target contact information.

Further, the server may only synchronize the usage state of the target contact information to contacts whose preset contact lists have the target contact information. When the target contact information do not exist in the preset contact lists, it indicates that there may be no friend relationship between the target user and the contacts corresponding to the preset contact lists. Thus, the server does not need to synchronize the usage state of the target contact information (of the target user) to contacts corresponding to the preset contact lists, which reduces possibility of wasting server source, and also guarantees safety of the target contact information at the same time.

It should be noted that, based on the methods for synchronizing states as shown in FIG. 1 to FIG. 5A, when the server synchronizes the usage state of the target contact information to contacts in the target contact list, the usage state of the target contact information is directly updated to terminals corresponding to the contacts in the target contact list. Optionally, after the server synchronizes the usage state of the target contact information to contacts in the target contact list, the contacts in the target contact list may modify the usage state of the stored target contact information.

For example, after the user B changes his/her cell phone number, the “non-use” usage state of original cell phone number 12355145422 for user B is sent to the server, and the server synchronizes the “non-use” usage state of the cell phone number to a user A, where user A is a friend of the user B that is include in the contact list of user B. Referring to FIG. 5B, the user A edits the usage state of the cell phone number of the user B to “non-use” in the contact list of user A's cell phone 410.

The following is embodiments of devices according to the present disclosure, which may be configured to perform the embodiments of methods of the present disclosure. Details not disclosed in the embodiments of devices may be referred to the embodiments of methods.

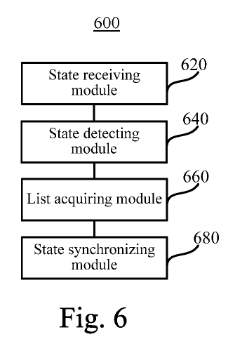

FIG. 6 is a block diagram showing a device 600 for synchronizing states according to an exemplary embodiment. Referring to FIG. 6, the device 600 for synchronizing states includes, but not limited to a state receiving module 620, a state detecting module 640, a list acquiring module 660, and a state synchronizing module 680.

The state receiving module 620 is configured to acquire a usage state of target contact information of a target user.

The state detecting module 640 is configured to detect whether the usage state of the target contact information has changed based on previously-stored usage states of respective contact information.

The list acquiring module 660 is configured to, when the usage state of the target contact information has changed, acquire a target contact list of the target user.

The state synchronizing module 680 is configured to synchronize the usage state of the target contact information to contacts in the target contact list.

Accordingly, in the device 600 for synchronizing states provided by embodiments of the present disclosure, a usage state of target contact information of a target user is acquired; it is detected whether the usage state of the target contact information has changed based on previously stored usage states of respective contact information; if the usage state of the target contact information has changed, a target contact list of the target user is acquired; and the usage state of the target contact information is synchronized to contacts in the target contact list. A server detects whether the usage state of the target contact information has changed, and automatically synchronizes the usage state of the target contact information to the contacts in the target contact list when it is detected that the usage state of the target contact information has changed. It solves a problem that a user needs to manually send changed contact information to each contact in a contact list after he/she changes his/her contact information; and achieves an effect that the usage state of the target contact information is automatically synchronized to the contacts in the target contact list when the usage state of the target contact information has changed, i.e. automatically synchronizing the usage state of the target contact information.

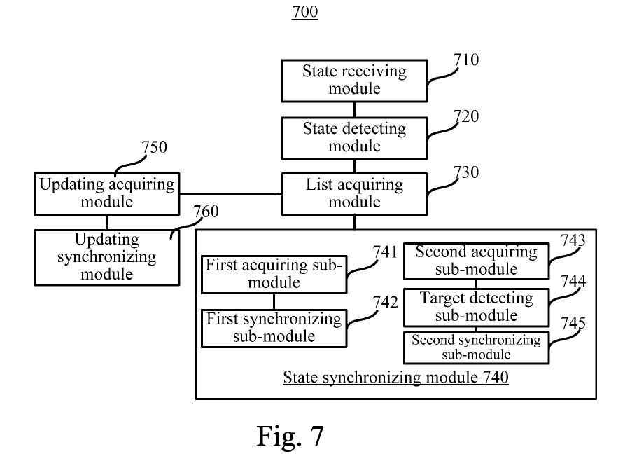

FIG. 7 is a block diagram showing a device 700 for synchronizing states according to another exemplary embodiment. Referring to FIG. 7, the device 700 for synchronizing states includes, but not limited to a state receiving module 710, a state detecting module 720, a list acquiring module 730 and a state synchronizing module 740.

The state receiving module 710 is configured to acquire a usage state of target contact information of a target user.

The state detecting module 720 is configured to detect whether the usage state of the target contact information has changed based on previously-stored usage states of respective contact information.

The list acquiring module 730 is configured to, if the usage state of the target contact information has changed, acquire a target contact list of the target user.

The state synchronizing module 740 is configured to synchronize the usage state of the target contact information to contacts in the target contact list.

In the present embodiment, the state synchronizing module 740 may include a first acquiring sub-module 741 and a first synchronizing sub-module 742.

The first acquiring sub-module 741 is configured to, for each contact in the target contact list, acquire a usage state of contact information of the contact.

The first synchronizing sub-module 742 is configured to synchronize the usage state of the target contact information to the contact whose contact information is “in-use” in the target contact list.

In the present embodiment, the state synchronizing module 740 may further include a second acquiring sub-module 743, a target detecting sub-module 744, and a second synchronizing sub-module 745.

The second acquiring sub-module 743 is configured to, for each contact in the target contact list, acquire a preset contact list of the contact.

The target detecting sub-module 744 is configured to detect whether the target contact information exists in the preset contact list.

The second synchronizing sub-module 745 is configured to, if the target contact information exists in the preset contact list, synchronize the usage state of the target contact information to the contact corresponding to the preset contact list.

Optionally, in the present embodiment, the device may further include an updating acquiring module 750 and an updating synchronizing module 760:

The updating acquiring module 750 is configured to acquire updated target contact information.

The updating synchronizing module 760 is configured to synchronize the updated target contact information to contacts in the target contact list.

Accordingly, in the device 700 for synchronizing states provided by embodiments of the present disclosure, a usage state of target contact information of a target user is acquired; it is detected whether the usage state of the target contact information has changed based on previously-stored usage states of respective contact information; if the usage state of the target contact information has changed, a target contact list of the target user is acquired; and the usage state of the target contact information is synchronized to contacts in the target contact list. A server detects whether the usage state of the target contact information has changed, and automatically synchronizes the usage state of the target contact information to the contacts in the target contact list when it is detected that the usage state of the target contact information has changed. It solves a problem that a user needs to manually send changed contact information to each contact in a contact list after he/she changes his/her contact information; and achieves an effect that the usage state of the target contact information is automatically synchronized to the contacts in the target contact list when the usage state of the target contact information has changed, i.e. automatically synchronizing the usage state of the target contact information.

Further, the server may only synchronizes the usage state of the target contact information to contacts whose contact information is “in-use” in the target contact list, which achieves that contacts whose contact information is “non-used” in the target contact list cannot receive the usage state of the target contact information synchronized by the server. Thus, the server does not need to synchronize the usage state of the target contact information to contacts whose contact information is “non-used”, which reduces possibility of wasting server source, and also guarantees safety of the target contact information at the same time.

Further, the server may only synchronizes the usage state of the target contact information to contacts whose preset contact lists have the target contact information. When the preset contact lists do not have the target contact information, it indicates that there may be no friend relationship between the target user and the contacts corresponding to the preset contact lists. Thus, the server does not need to synchronize the usage state of the target contact information to contacts corresponding to the preset contact lists, which reduces possibility of wasting server source, and also guarantees safety of the target contact information at the same time.

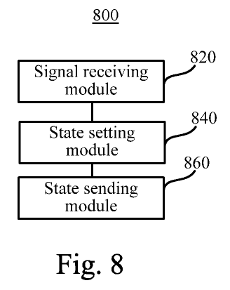

FIG. 8 is a block diagram showing a device 800 for synchronizing states according to an exemplary embodiment. Referring to FIG. 8, the device 800 for synchronizing states includes, but not limited to a signal receiving module 820, a state setting module 840, and a state sending module 860.

The signal receiving module 820 is configured to receive a setting signal.

The state setting module 840 is configured to set a usage state of target contact information based on the setting signal.

The state sending module 860 is configured to send the set usage state of the target contact information to a server, such that the server synchronizes the usage state of the target contact information to contacts in a contact list of a terminal when detecting that the usage stage of the target contact information has changed.

Accordingly, in the device 800 for synchronizing states provided by embodiments of the present disclosure, a setting signal is received; a usage state of target contact information is set based on the setting signal; the set usage state of the target contact information is sent to a server, such that the server synchronizes the usage state of the target contact information to contacts in a contact list of a terminal when detecting that the usage stage of the target contact information has changed. The terminal sets a usage state of target contact information based on the setting signal and sends the set usage state to a server. It solves a problem that a user needs to manually send changed contact information to each contact in a contact list after he/she changes his/her contact information; and achieves an effect that the usage state of the target contact information is automatically synchronized to the contacts in the target contact list when the usage state of the target contact information has changed, i.e. automatically synchronizing the usage state of the target contact information.

As for the devices 600, 700, and 800 according to the above embodiments, specific implementing manners of the operations of all the modules have been described in detail in the embodiments of the related method, which will not be described repeatedly herein.

One exemplary embodiment of the present disclosure provides a device for synchronizing states, which can implement the method for synchronizing states provided by the present disclosure. The device for synchronizing states includes: a processor and a memory for storing instructions executable by the processor.

The processor is configured to execute the instructions stored on the memory to perform any one or more of the features described herein. In particular, the processor may execute the instructions to perform the steps that follow.

Acquire a usage state of target contact information of a target user.

Detect whether the usage state of the target contact information has changed based on previously-stored usage states of respective contact information.

If the usage state of the target contact information has changed, acquire a target contact list of the target user.

Synchronize the usage state of the target contact information to contacts in the target contact list.

One exemplary embodiment of the present disclosure provides a device for synchronizing states, which can implement the method for synchronizing states provided by the present disclosure. The device for synchronizing states includes: a processor and a memory for storing instructions executable by the processor.

The processor may execute the instructions to perform the steps that follow.

Receive a setting signal.

Set a usage state of target contact information based on the setting signal.

Send the set usage state of the target contact information to a server, such that the server synchronizes the usage state of the target contact information to contacts in a contact list of a terminal when detecting that the usage stage of the target contact information has changed.

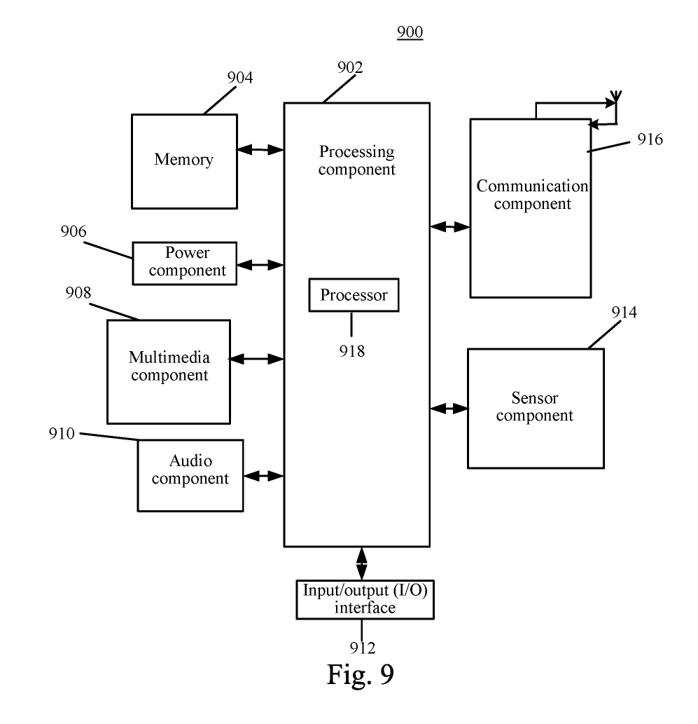

FIG. 9 is a block diagram showing a device 900 for synchronizing states according to an exemplary embodiment. For example, the device 900 may be a mobile phone, a computer, a digital broadcast terminal, a messaging device, a gaming console, a tablet, a medical device, exercise equipment, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 918 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operations of the device 900. Examples of such data include instructions for any applications or methods operated on the device 900, contact data, phonebook data, messages, pictures, video, etc. The memory 904 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In embodiments, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide state assessments of various aspects of the device 900. For instance, the sensor component 914 may detect an open/closed state of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may further include a light sensor, such as a CMOS or CCD image sensor, for use in imaging applications. In embodiments, the sensor component 914 may further include an accelerometer sensor, a gyroscope sensor, a magnetic sensor, a pressure sensor or a temperature sensor.

The communication component 916 is configured to facilitate communication, wired or wirelessly, between the device 900 and other devices. The device 900 may access a wireless network based on a communication standard, such as WiFi, 2Q or 3Q or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described method for synchronizing states.

In exemplary embodiments, there is further provided a non-transitory computer-readable storage medium including instructions, such as included in the memory 904, executable by the processor 918 in the device 900, for performing the above-described methods for synchronizing states. For example, the non-transitory computer-readable storage medium may be a ROM, a RAM, a CD-ROM, a magnetic tape, a floppy disc, an optical data storage device, and the like.

Each module, submodule, or unit discussed herein, may take the form of a packaged functional hardware unit designed for use with other components, a portion of a program code (e.g., software or firmware) executable by the processor 918 or the processing circuitry that performs a particular function of related functions, or a self-contained hardware or software component that interfaces with a larger system, for example.

Other embodiments of the disclosure may be apparent to those skilled in the art from consideration of the specification and practice of the disclosure disclosed here. This application is intended to cover any variations, uses, or adoptions of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for synchronizing states, at a server, the method comprising:
receiving, from a mobile computing device, a usage state for a target contact information corresponding to a target user;
comparing the usage state to a previously-stored usage state for the target contact information;
determining whether the usage state has changed based on the comparison;
when the usage state is determined to have changed, acquiring a target contact list for the target user, wherein the target contact list includes contacts and respective contact information; and
synchronizing the usage state to the contacts in the target contact list.

2. The method of claim 1, wherein synchronizing the usage state to the contacts in the target contact list comprises:
for each contact in the target contact list, acquiring a usage state of respective contact information of the contact; and
synchronizing the usage state of the target contact information to contacts having an “in-use” usage state.

3. The method of claim 1, wherein synchronizing the usage state to the contacts in the target contact list comprises:
for each contact in the target contact list, acquiring a respective contact list for the contact;
determining whether the target contact information is included in the respective contact list; and
when the target contact information is determined to be included in the respective contact list, synchronizing the usage state of the target contact information to the contacts determined to include the target contact information in their respective contact list.

4. The method of claim 1, wherein when the usage state for the target contact information received from the mobile computing device is a non-use state, the method further comprises:
acquiring updated target contact information; and
synchronizing the updated target contact information to transmit the updated target contact information to contacts in the target contact list.

5. The method of claim 1, wherein when the usage state for the target contact information received from the mobile computing device is a non-use state, the method further comprises:
acquiring updated target contact information; and
synchronizing the updated target contact information to transmit a message identifying the updated target contact information to contacts in the target contact list.

6. The method of claim 1, wherein when the usage state for the target contact information received from the mobile computing device is an in-use state, the method further comprises:
acquiring updated target contact information; and
synchronizing the updated target contact information to transmit the updated target contact information to contacts in the target contact list.

7. The method of claim 1, wherein the usage state is set according to a setting signal received at the mobile computing device.

8. A device for synchronizing states, the device comprising:
a processor; and
a memory configured to store processor executable instructions;
wherein the processor is configured to execute the processor executable instructions to:
receive a usage state of target contact information of a target user from a mobile computing device;
compare the usage state to a previously-stored usage state for the target contact information;
determine whether the usage state has changed based on the comparison;
when the usage state is determined to have changed, acquire a target contact list for the target user wherein the target contact list includes contacts and respective contact information; and
synchronize the usage state to the contacts in the target contact list.

9. The device of claim 8, wherein the processor is configured to execute the processor executable instructions to synchronize the usage state by:
for each contact in the target contact list, acquiring a usage state of respective contact information of the contact; and
synchronizing the usage state of the target contact information to contacts having an “in-use” usage state.

10. The device of claim 8, wherein to synchronize the usage state, the processor is configured to execute the processor executable instructions to:
for each contact in the target contact list, acquire a respective contact list for the contact;
determine whether the target contact information is included in the respective contact list; and
when the target contact information is determined to be included in the respective contact list, synchronize the usage state of the target contact information to the contacts determined to include the target contact information in their respective contact list.

11. The device of claim 8, wherein when the usage state for the target contact information received from the mobile computing device is a non-use state, the processor is further configured to execute the processor executable instructions to:
acquire updated target contact information; and
synchronize the updated target contact information to transmit the updated target contact information to contacts in the target contact list.

12. The device of claim 8, wherein when the usage state for the target contact information received from the mobile computing device is a non-use state, the processor is further configured to execute the processor executable instructions to:
acquire updated target contact information; and
synchronize the updated target contact information to transmit a message identifying the updated target contact information to contacts in the target contact list.

13. The device of claim 8, wherein when the usage state for the target contact information received from the mobile computing device is an in-use state, the processor is further configured to execute the processor executable instructions to:
acquire updated target contact information; and
synchronize the updated target contact information to transmit the updated target contact information to contacts in the target contact list.

14. The device of claim 8, wherein the memory is further configured to store the target contact list.

15. The device of claim 14, wherein the memory is further configured to store contact lists for contacts included in the target contact list.

16. The device of claim 8, wherein the processor is further configured to execute the processor executable instructions to:
identify contacts in the target contact list that includes the target contact information; and
synchronize the usage state to the contacts in the target contact list identified to include the target contact information.

17. The device of claim 16, wherein the processor is further configured to execute the processor executable instructions to:
withhold synchronizing the usage state for contacts in the target contact list identified not to include the target contact information.

18. The device of claim 8, wherein the processor is further configured to execute the processor executable instructions to:
identify contacts in the target contact list that are in an in-use usage state;
synchronize the usage state to the contacts in the target contact list identified to be in an in-use usage state.

19. The device of claim 8, wherein the processor is further configured to execute the processor executable instructions to:
identify contacts in the target contact list that are in a non-use usage state;
withhold synchronizing the usage state to the contacts in the target contact list identified to be in a non-use usage state.

20. A device for synchronizing states, comprising:
a processor; and
a memory for storing processor executable instructions;
wherein the processor is configured to execute the processor executable instructions to:
receive a setting signal input through a graphical user interface displayed on a display screen of the device;
set a usage state for target contact information of a target user based on the setting signal; and
send the usage state to a server, wherein the server synchronizes the usage state to contacts in a target contact list for the target user when the server determines the usage state has changed compared to a previously stored usage state for the target contact information.
